(19) United States
(12) Patent Application Publication
(10) Pub. No.: US 2024/0094237 A1
(43) Pub. Date: Mar. 21, 2024

(54) AUTOMATIC METHOD AND DEVICE FOR REAGENT COMPENSATION AND STAINING INSTRUMENT

(71) Applicant: Leica Biosystems Nussloch GmbH, Nussloch (DE)

(72) Inventors: Huan SUN, Shanghai (CN); Xuefang WU, Shanghai (CN); Ting WANG, Shanghai (CN); Xueyan PU, Shanghai (CN)

(21) Appl. No.: 18/523,213

(22) Filed: Nov. 29, 2023

Related U.S. Application Data
(63) Continuation of application No. PCT/CN21/99749, filed on Jun. 11, 2021.

(51) Int. Cl. G01N 35/10; G01N 1/30; G01N 1/31; G01N 35/02

(52) U.S. Cl. CPC G01N 35/1065; G01N 1/30; G01N 1/31; G01N 35/026; G01N 2001/302; G01N 2001/305; G01N 2035/0401

(57) ABSTRACT

A slide staining apparatus for staining of cells and tissue samples on slides before pathological analysis. The apparatus is operable to stain multiple sets of slides simultaneously and configured with a reagent system having a plurality of reagents. The Apparatus includes a slide counter, a controller having a non-transitory memory component with instructions thereon, and a processor configured to determine a count of a set of received slides since the regent system was installed. When the count is below a threshold, the first protocol is used. When the count is above the threshold, slides in-progress are stained, and newly received slides are stained with a second protocol, the first protocol having an eosin reagent step followed by a 95% ethanol reagent step of a first duration, the second protocol having an eosin reagent step followed by a 95% ethanol reagent step of a second duration less than the first duration.

### BACKGROUND

### Technical Field

This technology relates to an automated apparatus and methods for staining biological samples arranged on slides, and in particular for changing a protocol of a reagent system of an automated slide staining apparatus processing a large number (e.g., thousands) of slides.

### Description of the Related Technology

The detection, identification, quantification, and characterization of cells of interest through testing of biological samples is an important aspect of medical diagnosis and research. Typically, a biological sample (e.g., as tissue samples, samples of any cells or other biological materials) are prepared for scanning and/or viewing by staining the sample which helps to emphasize important features when viewed or in an image generated from the stained sample. Existing tissue sample treatment processing prior to viewing or scanning can include a number of steps, including obtaining a biological sample (“sample”), placing the sample on a slide, and staining the sample with a staining protocol which consistently stains the sample, and placing a coverslip over the stained sample.

A staining protocol can include exposing the sample to a number of reagents and baths in a predetermined order for a predetermined time, and can involve several or many steps. Automated slide stainer instruments automatically process tissue samples on slides and can perform slide staining on numerous sets of slides (e.g., that are arranged in baskets) simultaneously. In an existing example, an automated staining apparatus is configured to treat and stain hundreds or thousands of samples using a reagent system that has been loaded into the apparatus, and using a predetermined protocol to produce consistent results. While processing a high volume of slides with the same reagent systems, the reagents themselves may change due to their use. Existing automated staining apparatuses operate on protocols that are consistent for a set or reagents, and tend to determine reagent replenishment conditions based on a time period of use. However, as thousands of slides are processed, prior to replenishment, or loading a new reagent systems, the characteristics of reagents may change, which can lead to inconsistency in the staining process. As pathologist and other users of stained tissue samples rely on the consistency of the stained sample to determine characteristics of cells in the tissue sample, it is important for an automated slide staining apparatus to produce consistently stained slides throughput the lifecycle of a batch of reagents.

### SUMMARY

Embodiments of systems and methods for controlling automated slide stain processing that changes a staining protocol prior to replenishment of reagents are disclosed herein. For example, a first protocol is used for a first portion of a slide staining process that uses a certain reagent system that is installed in an automated slide staining apparatus. The slides that have been loaded into the slide staining apparatus are counted, and when a certain slide count has been reached, the apparatus is controlled such that it does not start to process additional slides using the first protocol but let's the slides that are being processed already complete the staining process using the first protocol. Then, still using the same reagent system, processing additional slides with the slide staining apparatus in the second protocol until a second slide count has been reached. When the second slide count has been reached, the slide staining apparatus completes staining slides are in progress the second protocol but does not start staining any additional slides. Accordingly, one innovation includes a method for controlling an automatic slide staining apparatus for staining cells and tissue samples on slides before pathological analysis, the slide staining apparatus operable to stain multiple sets of slides simultaneously and configured with a reagent system having a plurality of reagents. The method can include (a) determine a cumulative count of a set of received slides since the regent system was installed, each set of slides having one or more slides, (b) in response to the cumulative count being less than a first slide count S1, stain the set of slides using a first protocol having a plurality of steps for staining the set of slides in the reagent system, a step of the plurality of steps subjecting the set of slides to an eosin reagent followed by subjecting the set of slides to an alcohol reagent for a first time period, and repeat process items (a)-(b), (c) in response to the cumulative slide count being greater than the first slide count S1, continue staining in-progress slides that are currently being processed with the first protocol, but do not start staining slides that have not yet begun being processed with the first protocol, after staining of the in-progress slides has been completed: (d) receive another set of slides having a biological sample thereon, (e) determine a cumulative count of the slides received since the regent system was installed, (f) in response to the cumulative count being less than a second slide count S2, stain the received set of slides using a second protocol having a plurality of steps for staining the set of slides in the reagent system, a step of the second protocol including subjecting the set of slides to an eosin reagent followed by subjecting the set of slides to an alcohol for a second time period where the second time period is shorter than the first time period, and repeat process steps (d)-(f), and (g) in response to the cumulative slide count being greater than the second slide count S2, continue staining in-progress slides currently being processed with the second protocol, but not start staining slides that have not yet begun being processed with the second protocol.

Embodiments of such methods may have one or more other aspects. In some embodiments, the first slide count S1 is greater than or equal to 2200 and less than or equal to 2600. In some embodiments, the first slide count S1 is greater than or equal to 2300 and less than or equal to 2500. In some embodiments, the first slide count S1 is greater than or equal to 2350 and less than or equal to 2450. In some embodiments, the first slide count is 2400. In some embodiments, the first slide count S1 equal 0.8*S2. In some embodiments, the first slide count S1 is between 0.7*S2 and 0.9*S2. In some embodiments, second slide count S2 is between 2800 and 3200. In some embodiments, the second slide count S2 is between 2900 and 3100. In some embodiments, the second slide count S2 is 3000. In any of the above embodiments, the first protocol and the second protocol have two or more of the same steps, before the eosin reagent step, of the same duration. In any of the above embodiments, the first protocol and the second protocol include at least two of the same reagent steps after the eosin reagent step, wherein the at least two reagent steps of the second protocol after the eosin reagent step are of a shorter duration than the corresponding two or more steps of the first protocol. In any of the above embodiments, the first and second protocols sequentially include, after the eosin reagent step, a 95% ethanol reagent step, a first 100% ethanol reagent step, a second 100% ethanol reagent step, and first xylene step, and a second xylene step. In some embodiments, the 95% ethanol reagent step of the first protocol has a duration of more than three times as long as the 95% ethanol reagent step of the second protocol.

In some embodiments of a method for controlling automated slide staining, the 95% ethanol reagent step (after the eosin reagent step) of the first protocol has a duration of about one minute, and the 95% ethanol reagent step (after the eosin reagent step) of the second protocol has a duration of about 5 seconds. In some embodiments, the first protocol sequentially includes, after the eosin reagent step, a 95% ethanol reagent step of one minute, a first 100% ethanol reagent step of one minute, a second 100% ethanol reagent step of one minute, a first xylene step of 30 seconds, and a second xylene step of 30 seconds. The second protocol sequentially includes, after the eosin reagent step, a 95% ethanol reagent step of about 5 seconds, a first 100% ethanol reagent step of about one minute, a second 100% ethanol reagent step of about one minute, a first xylene step of about 30 seconds, and a second xylene step of about 30 seconds. In some embodiments, the (b) determine a cumulative count of the slides received includes counting the slides loaded into a rack of the automatic slide stating apparatus with a slide counter. In some embodiments, the method includes further comprises generating an alert when the slide count S2 has occurred. In some embodiments, the alert comprises an indicator or message displayed on a display screen of the automatic slide staining apparatus. In some embodiments, such methods further comprises displaying the slide count on a display screen of the automatic slide staining apparatus.

Another innovation includes an automatic slide staining apparatus for staining of cells and tissue samples on slides before pathological analysis, the slide staining apparatus operable to stain multiple sets of slides simultaneously and configured with a reagent system having a plurality of reagents, the apparatus comprising a slide counter configured to count slides provided to the apparatus for staining, a controller having a non-transitory memory component with instructions thereon, and one or more processors configured to execute the instructions to: (a) determine a cumulative count of a set of received slides since the regent system was installed, each set of slides having one or more slides, (b) in response to the cumulative count being less than a first slide count S1, stain the set of slides using a first protocol having a plurality of steps for staining the set of slides in the reagent system, a step of the plurality of steps subjecting the set of slides to an eosin reagent followed by subjecting the set of slides to an alcohol reagent for a first time period, and repeat process items (a)-(b), (c) in response to the cumulative slide count being greater than the first slide count S1, continue staining in-progress slides that are currently being processed with the first protocol, but do not start staining slides that have not yet begun being processed with the first protocol, after staining of the in-progress slides has been completed: (d) receive another set of slides having a biological sample thereon, (e) determine a cumulative count of the slides received since the regent system was installed, (f) in response to the cumulative count being less than a second slide count S2, stain the received set of slides using a second protocol having a plurality of steps for staining the set of slides in the reagent system, a step of the second protocol including subjecting the set of slides to an eosin reagent followed by subjecting the set of slides to an alcohol for a second time period where the second time period is shorter than the first time period, and repeat process steps (d)-(f), and (g) in response to the cumulative slide count being greater than the second slide count S2, continue staining in-progress slides currently being processed with the second protocol, but not start staining slides that have not yet begun being processed with the second protocol. In various embodiments, the first slide count S1 is greater than or equal to 2200 and less than or equal to 2600, or the first slide count S1 is greater than or equal to 2300 and less than or equal to 2500, or the first slide count S1 is greater than or equal to 2350 and less than or equal to 2450, or wherein the first slide count is 2400. In some embodiments, the first slide count S1 equal 0.8*S2, or the first slide count S1 is between 0.7*S2 and 0.9*S2, or the second slide count S2 is between 2800 and 3200, or the second slide count S2 is between 2900 and 3100, or the second slide count S2 is 3000. In some embodiments, the first protocol and the second protocol have two or more of the same steps, before the eosin reagent step, of the same duration. In some embodiments, the first protocol and the second protocol include at least two of the same reagent steps after the eosin reagent step, wherein at least one of the reagent steps of the second protocol after the eosin reagent step is of a shorter duration than the corresponding step of the first protocol. In some embodiments, the first protocol and the second protocol include at least two of the same reagent steps after the eosin reagent step, wherein one of the reagent steps of the second protocol after the eosin reagent step is of a shorter duration than the corresponding step of the first protocol. In some embodiments, the first and second protocols sequentially include, after the eosin reagent step, a 95% ethanol reagent step, a first 100% ethanol reagent step, a second 100% ethanol reagent step, and first xylene step, and a second xylene step. In some embodiments, the 95% ethanol reagent step of the first protocol has a duration of more than three times as long as the 95% ethanol reagent step of the second protocol. In some embodiments, the 95% ethanol reagent step of the first protocol has a duration of about one minute, and the 95% ethanol reagent step of the second protocol has a duration of at or about 5 seconds. In some embodiments, the first protocol sequentially includes, after the eosin reagent step, a 95% ethanol reagent step of one minute, a first 100% ethanol reagent step of one minute, a second 100% ethanol reagent step of one minute, a first xylene step of at or about 30 seconds, and a second xylene step of at or about 30 second, and the second protocol sequentially includes, after the eosin reagent step, a 95% ethanol reagent step of at or about 5 seconds, a first 100% ethanol reagent step of about one minute, a second 100% ethanol reagent step of about one minute, a first xylene step of at or about 30 seconds, and a second xylene step of at or about 30 seconds. In some embodiments, (b) determine a cumulative count of the slides received comprising counting the slides loaded into a rack of the automatic slide stating apparatus with a slide counter. In some embodiments, the one or more processors are further configured to execute instructions to generate an alert when the slide count S2 has occurred. In some embodiments, the apparatus further comprises a display screen, and the one or more processors are further configured to execute instructions to display the alert on the display screen. In some embodiments, the apparatus further comprises a display screen, and the one or more processors are further configured to execute instructions to display the slide count on the display screen.

Another innovation, a method for controlling an automatic slide staining apparatus for staining of cells and tissue samples on slides before pathological analysis, the slide staining apparatus operable to stain multiple sets of slides simultaneously and configured with a reagent system having a plurality of reagents, the method includes, receiving slides having a biological sample thereon; determining a cumulative count of the slides received since the regent system was installed; in response to the cumulative count being less than a first slide count S1, stain the slides using a first protocol having a plurality of steps for staining the set of slides using the reagent system, a step of the plurality of steps subjecting the set of slides to an eosin reagent followed by processing the slides to an alcohol reagent for a first time period; in response to the cumulative slide count being equal to or greater than the first slide count S1, continue staining in-progress slides that are currently being processed with the first protocol, but do not start staining slides that have not yet begun being processed with the first protocol; and after staining of the in-progress slides has been completed, stain slides with using a second protocol, a step of the second protocol including processing the slides with an eosin reagent followed by processing the slides with an alcohol for a second time period, the second time period being shorter than the first time period. In some embodiments, in response to the cumulative slide count being greater than a second slide count S2, continue staining in-progress slides currently being processed with the second protocol, but do not start staining slides that have not yet begun being processed with the second protocol.

Another innovation includes a non-transitory computer readable medium for controlling a slide staining apparatus for staining of cells and tissue samples on slides, the computer readable medium having program instructions for causing a hardware processor to perform a method of determining a cumulative count of a set of received slides since a regent system was installed, each set of slides having one or more slides; in response to the cumulative count being less than a first slide count S1, staining the set of slides using a first protocol having a plurality of steps for staining the set of slides in the reagent system, step of the plurality of steps subjecting the set of slides to an eosin reagent followed by subjecting the set of slides to an alcohol reagent for a first time period, and repeat process items (a)-(b); in response to the cumulative slide count being greater than the first slide count S1, continuing to stain in-progress slides that are currently being processed with the first protocol, but do not start staining slides that have not yet begun being processed with the first protocol; after staining of the in-progress slides has been completed: receiving another set of slides having a biological sample thereon; determining a cumulative count of the slides received since the regent system was installed; (f) in response to the cumulative count being less than a second slide count S2, staining the received set of slides using a second protocol having a plurality of steps for staining the set of slides in the reagent system, a step of the second protocol including subjecting the set of slides to an eosin reagent followed by subjecting the set of slides to an alcohol for a second time period where the second time period is shorter than the first time period, and repeat process steps (d)-(f); and (g) in response to the cumulative slide count being greater than the second slide count S2, continuing to stain in-progress slides currently being processed with the second protocol, but not start staining slides that have not yet begun being processed with the second protocol. In some embodiments, the first protocol and the second protocol include at least two of the same reagent steps after the eosin reagent step, wherein the at least two reagent steps of the second protocol after the eosin reagent step are of a shorter duration than the corresponding two or more steps of the first protocol. In some embodiments, the non-transitory computer the first and second protocols sequentially include, after the eosin reagent step, a 95% ethanol reagent step, a first 100% ethanol reagent step, a second 100% ethanol reagent step, a first xylene step, and a second xylene step. In some embodiments, the 95% ethanol reagent step of the first protocol has a duration of more than three times as long as the 95% ethanol reagent step of the second protocol. In some embodiments, the 95% ethanol reagent step of the first protocol has a duration of about one minute, and the 95% ethanol reagent step of the second protocol has a duration of about 5 seconds. In some embodiments, the first protocol sequentially includes, after the eosin reagent step, a 95% ethanol reagent step of one minute, a first 100% ethanol reagent step of one minute, a second 100% ethanol reagent step of one minute, a first xylene step of about 30 seconds, and a second xylene step of about 30 seconds, and the second protocol sequentially includes, after the eosin reagent step, a 95% ethanol reagent step of about 5 seconds, a first 100% ethanol reagent step of about one minute, a second 100% ethanol reagent step of about one minute, a first xylene step of about 30 seconds, and a second xylene step of about 30 seconds.

### BRIEF DESCRIPTION OF THE DRAWINGS

The features and advantages of the multi-stage stop devices, systems, and methods described herein will become more fully apparent from the following description and appended claims, taken in conjunction with the accompanying drawings. These drawings depict only several embodiments in accordance with the disclosure and are not to be considered limiting of its scope. In the drawings, similar reference numbers or symbols typically identify similar components, unless context dictates otherwise. The drawings may not be drawn to scale.

FIG. 1 is a block diagram illustrating an example of a system/environment where tissue samples are placed on slides, stained, imaged, and analyzed, according to some embodiments.

FIG. 2 depicts an example workflow for generating image data from a tissue sample block according to some embodiments.

FIG. 3A illustrates an example prepared tissue block according to some embodiments.

FIG. 3B illustrates an example prepared tissue block and an example prepared tissue slice 300B according to some embodiments.

FIG. 4 shows an example imaging device, according to one embodiment.

FIG. 5 is illustrates an example of an automated slide staining apparatus (or “automated slide stainer”) that includes a slide counter for counting the number of slides that are being processed for staining, and includes a control system that operates the apparatus to stain samples on slides (which may be referred to herein as “staining slides” for ease of reference) according to a first stain protocol using a reagent system, the control system using the slide count to determine when to change to a second stain protocol that takes into account a state of the reagent system caused by staining a number of slides. For ease of reference, staining a biological sample on a slide (e.g., a tissue or cell sample) will be referred to as staining a slide.

FIG. 6 is a block diagram that illustrates an example of interactions and processing actions of a slide staining assembly, a controller, and a slide counter of an automated slide stainer, according to some embodiments.

FIG. 7 is a process-flow diagram that illustrates a method of staining slides based at least in part on an input that indicates a cumulative count of a number of slides that have been processed for staining with a reagent system.

FIG. 8 is a table that illustrates an example of a first protocol of a reagent system for staining slides, according to some embodiments. The first protocol can be used, for example, as a default protocol for a first portion of the slide staining process illustrated in FIG. 7.

FIG. 9 is a table that illustrates an example of a second protocol of a reagent system for staining slides, according to some embodiments. The second protocol can be used, for example, as the protocol for a second portion of the slide staining process illustrated in FIG. 7, that is, the protocol that can be used after a certain count of slides has been reached (e.g., 2400 slides), and can continue to be used until the reagent system is replenished.

FIG. 10 is an example computing system controller which can implemented in an automated slide stainer to perform any of the processes described herein, for example, the slide staining process illustrated in FIG. 7.

### DETAILED DESCRIPTION

Features of automated slide staining systems and methods for staining slides using a first protocol with a reagent system for a first portion of a slide staining process, and a second protocol for the reagent system, for a second portion of the slide staining process before the reagent system is replenished, are described herein. Unless explicitly indicated, or implicitly apparent from context of the disclosure, features disclosed relating to one embodiment of an apparatus, method, or non-transitory computer readable medium can be included in other embodiments of an apparatus, method, or non-transitory computer readable medium. One example of such a slide staining apparatus, for staining of cells and tissue samples on slides before pathological analysis, the slide staining apparatus operable to stain multiple sets of slides simultaneously and configured with a reagent system having a plurality of reagents, includes a slide counter configured to count slides provided to the apparatus for staining. The apparatus can further include a controller having a non-transitory memory component with instructions thereon, and one or more processors configured to execute the instructions to (a) determine a cumulative count of a set of received slides since the regent system was installed, each set of slides having one or more slides, (b) in response to the cumulative count being less than a first slide count S1, stain the set of slides using a first protocol having a plurality of steps for staining the set of slides in the reagent system, a step of the plurality of steps subjecting the set of slides to an eosin reagent followed by subjecting the set of slides to an alcohol reagent for a first time period, and repeat process items (a)-(b). The non-transitory memory component can further have instructions to cause a processor to (c) in response to the cumulative slide count being greater than the first slide count S1, continue staining in-progress slides that are currently being processed with the first protocol, but do not start staining slides that have not yet begun being processed with the first protocol, after staining of the in-progress slides has been completed: (d) receive another set of slides having a biological sample thereon, (e) determine a cumulative count of the slides received since the regent system was installed, (f) in response to the cumulative count being less than a second slide count S2, stain the received set of slides using a second protocol having a plurality of steps for staining the set of slides in the reagent system, a step of the second protocol including subjecting the set of slides to an eosin reagent followed by subjecting the set of slides to an alcohol for a second time period where the second time period is shorter than the first time period, and repeat process steps (d)— (f); and (g) in response to the cumulative slide count being greater than the second slide count S2, continue staining in-progress slides currently being processed with the second protocol, but not start staining slides that have not yet begun being processed with the second protocol.

### System Overview

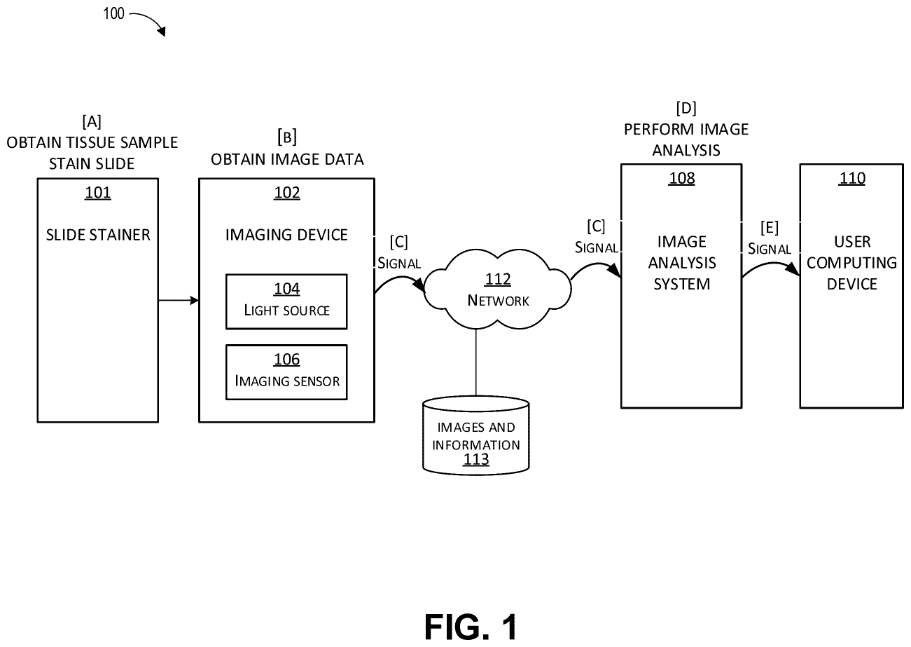

FIG. 1 illustrates an example environment 100 (e.g., a multispectral imaging system) in which a user and/or the multispectral imaging system may analyze a sample. The environment 100 includes an automated slide stainer 101 that is controlled to produce consistently stained slides based on one or more protocols. The environment 100 can also include an imaging device 102 that generates a digital representation (e.g., an image) of a stained slide. The digital representation can be communicated as signal [C] to a network 112 and then to an image analysis system 108 for processing (e.g., feature detection, feature measurements, etc.). The image analysis system 108 may perform image analysis on received image data. The image analysis system 108 can normalize the image data obtained using multispectral imaging for input to a machine learning algorithm, which may determine characteristics of the image. Results from the image analysis system 108 can be communicated as a signal [E] to one or more user computing devices 110.

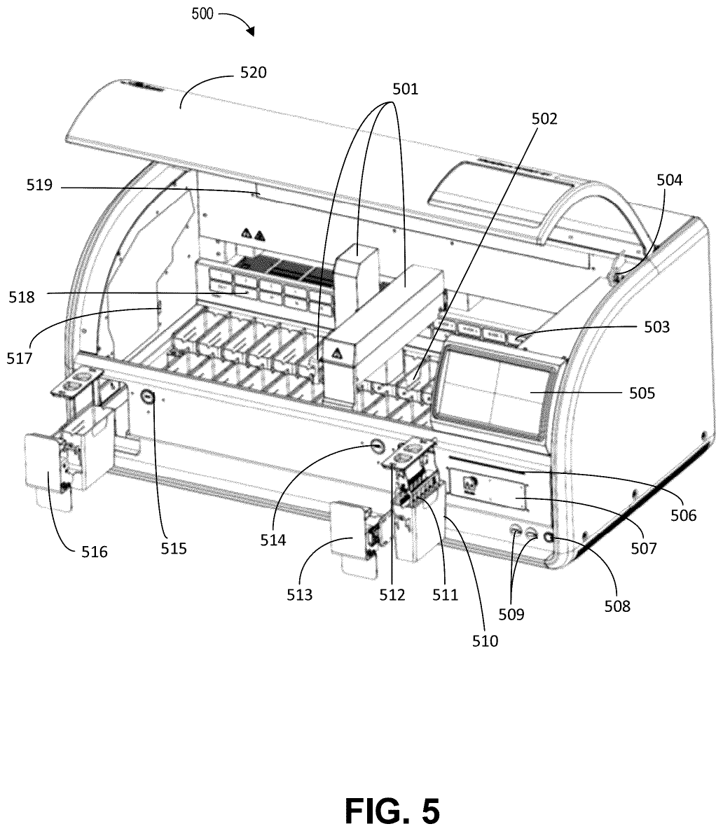

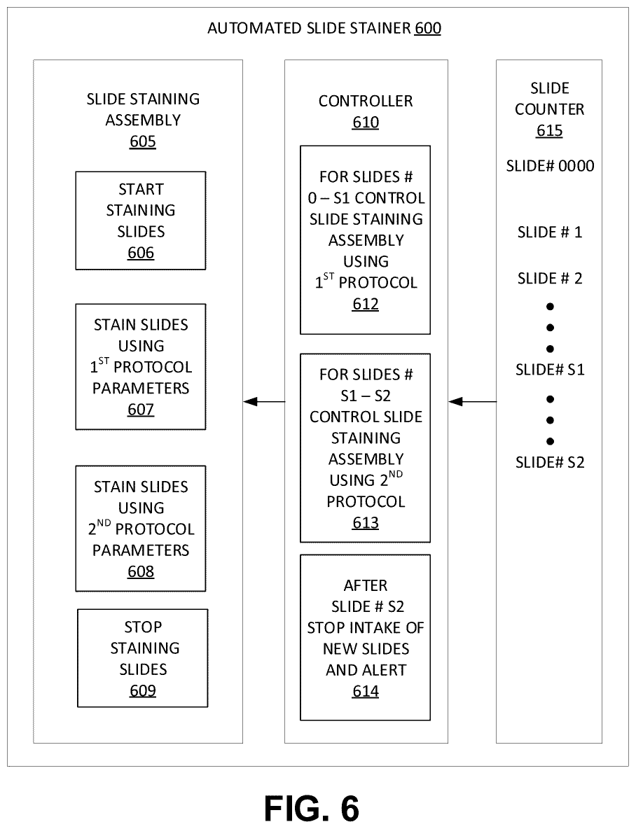

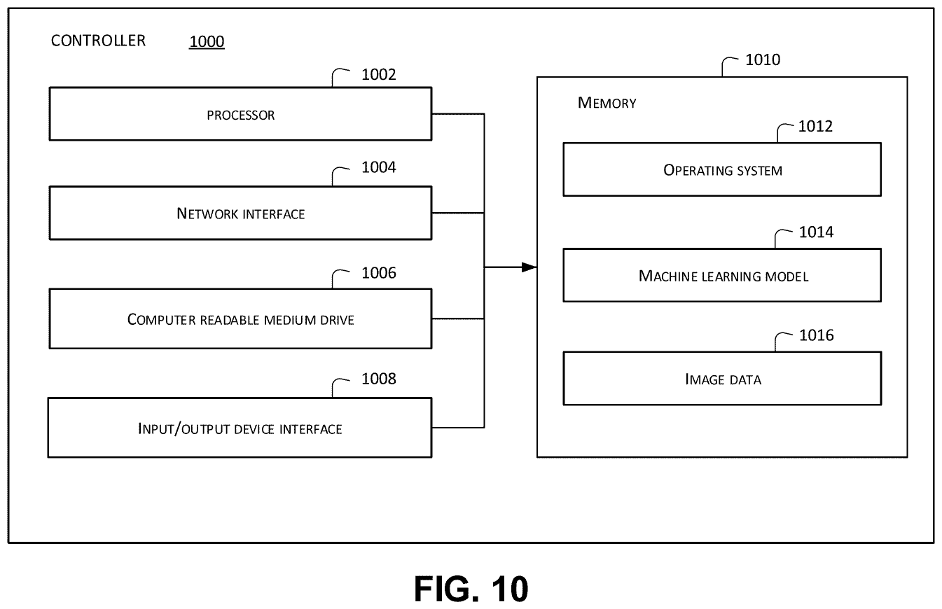

The slide stainer 101 may be controlled for staining of cells and tissue samples on slides before pathological analysis. It may be operable to stain multiple sets of slides simultaneously and configured with a reagent system having a plurality of reagents. The slide stainer 101 can include various structural features as illustrated in FIG. 5. It can also have a controller (shown in FIG. 10). In various embodiments, the slide stainer 101 can be configured (or controlled) to receive a set of slides having a biological sample thereon, each set of slides having one or more slides, determine a cumulative count of the slides received since the reagent system was installed, and in response to the cumulative count being less than a first slide count S1, stain the set of slides using a first protocol having a plurality of steps for staining the set of slides in the reagent system, a step of the plurality of steps subjecting the set of slides to an eosin reagent followed by subjecting the set of slides to an alcohol reagent for a first time period, and repeat the steps of receiving more slides and determining a cumulative count of the slides. The slide stainer 101 can start off using a first protocol when staining a certain number of slides with a reagent system, and then at a certain slide count indicative of a cumulative slide count that have been or are being currently processed by the same reagent system (i.e., without changing or replenishing the reagents) being greater than the first slide count S1, change to a different protocol until the reagent system needs to be replaced. This is discussed in greater detail in reference to FIGS. 6-9.

In some implementations, the imaging device 102 that is used to scan or “image” the sample includes a light source 104 configured to emit multispectral light onto the tissue sample(s) and the image sensor 106 configured to detect multispectral light emitted from the tissue sample. Multispectral imaging using the light source 104 can involve providing light to the tissue sample carried by a carrier within a range of frequencies. That is, the light source 104 may be configured to generate light across a spectrum of frequencies to provide multispectral imaging. In certain embodiments, the tissue sample may reflect light received from the light source 104, which can then be detected at the image sensor 106. In these implementations, the light source 142 and the image sensor 106 may be located on substantially the same side of the tissue sample. In other implementations, the light source 104 and the image sensor 106 may be located on opposing sides of the tissue sample. The image sensor 106 may be further configured to generate image data based on the multispectral light detected at the image sensor 106. In certain implementations, the image sensor 106 may include a high-resolution sensor configured to generate a high-resolution image of the tissue sample. The high-resolution image may be generated based on excitation of the tissue sample in response to laser light emitted onto the sample at different frequencies (e.g., a frequency spectrum).

The imaging device 102 may capture and/or generate image data for analysis. The imaging device 102 may include one or more of a lens, an image sensor, a processor, or memory. The imaging device 102 may receive a user interaction. The user interaction may be a request to capture image data. Based on the user interaction, the imaging device 102 may capture image data. In some embodiments, the imaging device 102 may capture image data periodically (e.g., every 10, 20, or 30 minutes). In other embodiments, the imaging device 102 may determine that an item has been placed in view of the imaging device 102 (e.g., a histological sample has been placed on a table and/or platform associated with the imaging device 102) and, based on this determination, capture image data corresponding to the item. The imaging device 102 may further receive image data from additional imaging devices, for example, the imaging device 102 may be a node that routes image data from other imaging devices to the image analysis system 108. In some embodiments, the imaging device 102 may be located within the image analysis system 108. For example, the imaging device 102 may be a component of the image analysis system 108. Further, the image analysis system 108 may perform an imaging function. In other embodiments, the imaging device 102 and the image analysis system 108 may be connected (e.g., wirelessly or wired connection). For example, the imaging device 102 and the image analysis system 108 may communicate over a network 112. Further, the imaging device 102 and the image analysis system 108 may communicate over a wired connection. In some embodiments, the image analysis system 108 may be connected to (via a wired or a wireless connection) a plurality of imaging devices.

The image analysis system 108 may perform the image analysis using an image analysis module (not shown in FIG. 1). The image analysis system 108 may receive the image data from an imaging device 102 and transmit the recommendation to a user computing device 110 for processing. Although some examples herein refer to a specific type of device as being the imaging device 102, the image analysis system 10, or the user computing device 11, the examples are illustrative only and are not intended to be limiting, required, or exhaustive. The image analysis system 108 may be any type of computing device (e.g., a server, a node, a router, a network host, etc.). Further, the imaging device 102 may be any type of imaging device (e.g., a camera, a scanner, a mobile device, a microscope, a laptop, etc.). In some embodiments, the imaging device 102 may include a plurality of imaging devices. Further, the user computing device 110 may be any type of computing device (e.g., a mobile device, a laptop, etc.). The image analysis system 108 may include various components for providing the features described herein. In some embodiments, the image analysis system 108 may include one or more image analysis modules to perform the image analysis of the image data received from the imaging device 102. The image analysis modules may perform one or more imaging algorithms using the image data.

The image analysis system 108 may be connected to the user computing device 110. The image analysis system 108 may be connected (via a wireless or wired connection) to the user computing device 110 to provide a recommendation for a set of image data. The image analysis system 108 may transmit the recommendation to the user computing device 110 via the network 112. In some embodiments, the image analysis system 108 and the user computing device 110 may be configured for connection such that the user computing device 110 can engage and disengage with image analysis system 108 in order to receive the recommendation. For example, the user computing device 110 may engage with the image analysis system 108 upon determining that the image analysis system 108 has generated a recommendation for the user computing device 110. Further, a particular user computing device 110 may connect to the image analysis system 108 based on the image analysis system 108 performing image analysis on image data that corresponds to the particular user computing device 110. For example, a user may be associated with a plurality of histological samples. Upon determining, that a particular histological sample is associated with a particular user and a corresponding user computing device 110, the image analysis system 108 can transmit a recommendation for the histological sample to the particular user computing device 110. In some embodiments, the user computing device 110 may dock with the image analysis system 108 in order to receive the recommendation.

In some implementations, the imaging device 102, the image analysis system 108, and/or the user computing device 110 may be in wireless communication. For example, the imaging device 102, the image analysis system 108, and/or the user computing device 110 may communicate over a network 112. The network 112 may include any viable communication technology, such as wired and/or wireless modalities and/or technologies. The network may include any combination of Personal Area Networks (“PANs”), Local Area Networks (“LANs”), Campus Area Networks (“CANs”), Metropolitan Area Networks (“MANs”), extranets, intranets, the Internet, short-range wireless communication networks (e.g., ZigBee, Bluetooth, etc.), Wide Area Networks (“WANs”)— both centralized and/or distributed—and/or any combination, permutation, and/or aggregation thereof. The network 112 may include, and/or may or may not have access to and/or from, the internet. The imaging device 102 and the image analysis system 108 may communicate image data. For example, the imaging device 102 may communicate image data associated with a histological sample to the image analysis system 108 via the network 112 for analysis. The image analysis system 108 and the user computing device 110 may communicate a recommendation corresponding to the image data. For example, the image analysis system 108 may communicate a diagnosis regarding whether the image data is indicative of a disease present in the tissue sample. In some embodiments, the imaging device 102 and the image analysis system 108 may communicate via a first network and the image analysis system 108 and the user computing device 110 may communicate via a second network. In other embodiments, the imaging device 102, the image analysis system 108, and the user computing device 110 may communicate over the same network.

With reference to an illustrative embodiment, at [A], the slide stainer 101 can process and stain a slide having a sample positioned thereon. Also, in some systems, the slide stainer can immediately place a coverplate over the stained sample after staining. An example of a combined instrument that can stain a sample and place a coverplate over the sample (sometimes referred to as a stainer and a coverslipper) is the Leica Histocore Spectra ST (Stainer) and Leica Histocore Spectra CV (coverslipper). At [B] the imaging device 102 can image (e.g., scan, capture, record, etc.) a sample on a slide to obtain a digital representation of the sample.

At [C], the imaging device 102 can transmit a signal to the image analysis system 108 representing the captured image data (e.g., the slice data and any other data imaged). The imaging device 102 can send the captured image data as an electronic signal to the image analysis system 108 via the network 112. The signal may include and/or correspond to a pixel representation of the slice data. It will be understood that the signal can include and/or correspond to more, less, or different image data. For example, the signal may correspond to multiple slices of a tissue block and may represent a first slice data and a second slice data.

At [D], the image analysis system 108 can perform image analysis on the slice data provided by the imaging device 102. To perform the image analysis, the image analysis system 108 may utilize one or more image analysis modules that can perform one or more image processing functions. For example, the image analysis module may include an imaging algorithm, a machine learning model, a convolutional neural network, or any other modules for performing the image processing functions. Based on performing the image processing functions, the image analysis module can determine a likelihood that the block data and the slice data corresponds to a tissue block. For example, an image processing functions may include an edge analysis of the block data and the slice data and based on the edge analysis, determine whether the block data and the slice data correspond to the same tissue block. The image analysis system 108 can obtain a confidence threshold from the user computing device 110, the imaging device 102, or any other device. In some embodiments, the image analysis system 108 can determine the confidence threshold based on a response by the user computing device 110 to a particular recommendation. Further, the confidence threshold may be specific to a user, a group of users, a type of tissue block, a location of the tissue block, or any other factor. The image analysis system 108 can compare the determined confidence threshold with the image analysis performed by the image analysis module. Based on this comparison, the image analysis system 108 can generate a recommendation indicating a recommended action for the user computing device 110 based on the likelihood that the block data and the slice data correspond to the same tissue block. In other embodiments, the image analysis system 108 can provide a diagnosis regarding whether the image data is indicative of a disease present in the tissue sample, for example, based on the results of a machine learning algorithm.

At [E], the image analysis system 108 can transmit a signal to the user computing device 110. The image analysis system 108 can send the signal as an electrical signal to the user computing device 110 via the network 112. The signal may include and/or correspond to a representation of the diagnosis. Based on receiving the signal, the user computing device 110 can determine the diagnosis. In some embodiments, the image analysis system 108 may transmit a series of recommendations corresponding to a group of slices. The image analysis system 108 can include, in the recommendation, a recommended action of a user. For example, the recommendation may include a recommendation for the user to review the slice data. Further, the recommendation may include a recommendation that the user does not need to review the tissue block and the slice.

### Imaging Prepared Blocks and Prepared Slices

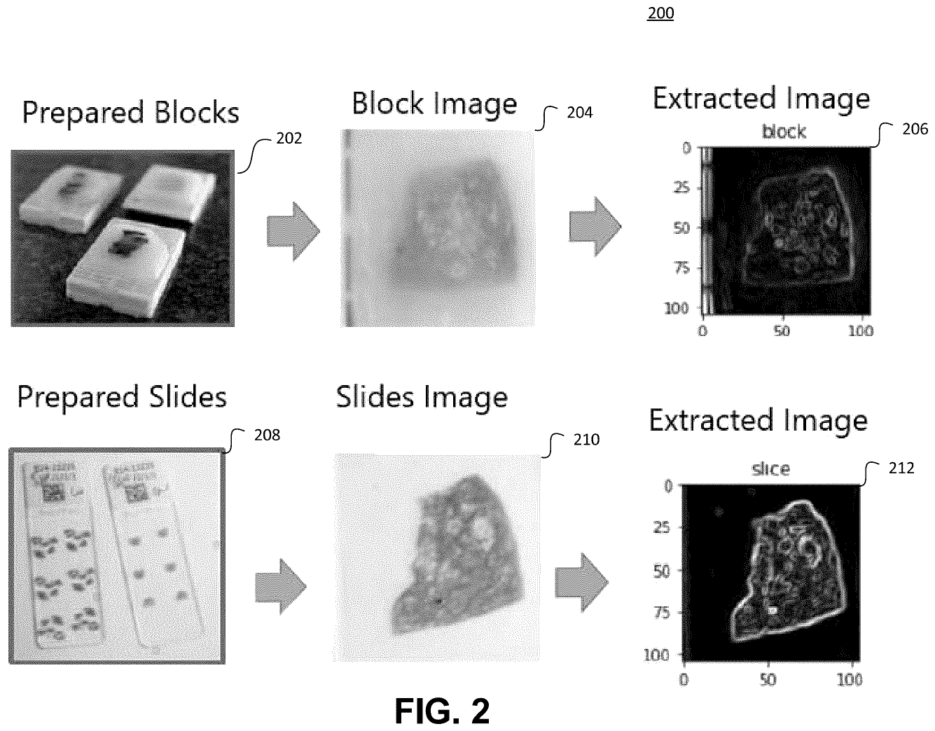

FIG. 2 depicts an example workflow 200 for generating image data from a tissue sample block according to some embodiments. The example workflow 200 illustrates a process for generating prepared blocks and prepared slices from a tissue block and generating pre-processed images based on the prepared blocks and the prepared slices. The example workflow 200 may be implemented by one or more computing devices. For example, the example workflow 200 may be implemented by a microtome, a stainer, a coverslipper, and an imaging device. Each computing device may perform a portion of the example workflow. For example, the microtome may cut the tissue block in order to generate one or more slices of the tissue block. The slices are transferred (e.g., manually) to the slides. The stainer may stain the slides. The coverslipper places a cover slip over each of the stained samples. After coverslipping, the imaging device can image each slide.

A tissue block can be obtained from a patient (e.g., a human, an animal, etc.). The tissue block may correspond to a section of tissue from the patient. The tissue block may be surgically removed from the patient for further analysis. For example, the tissue block may be removed in order to determine if the tissue block has certain characteristics (e.g., if the tissue block is cancerous). In order to generate the prepared blocks 202, the tissue block may be prepared using a particular preparation process by a tissue processor. In the tissue processor the tissue will be dehydrated with multiple steps of alcohol and then infiltrated with molten paraffin wax to stabilize the tissue. For example, the tissue (sample) may be embedded in a paraffin wax block. The result will be a prepared block 202 FIG. 2. This block is ready for cutting with a microtome. The tissue block may also be embedded using an optimal cutting temperature (“OCT”) compound. The preparation process may include one or more of a paraffin embedding, an OCT-embedding, or any other embedding of the tissue block. In the example of FIG. 2, the tissue block is embedded using paraffin embedding. Further, the tissue block is embedded within a paraffin wax block and mounted on a microscopic slide in order to formulate the prepared block.

The microtome can obtain a slice of the tissue block in order to generate the prepared slices 204. The microtome can use one or more blades to slice the tissue block and generate a slice (e.g., a section) of the tissue block. The microtome can further slice the tissue block to generate a slice with a preferred level of thickness. For example, the slice of the tissue block may be between 1 μm (0.001 millimeter) and 60 μm (0.06 millimeters). The microtome can provide the slice of the tissue block to a coverslipper. In generating the prepared slices 204, a stainer may also stain the slice of the tissue block using any staining protocol. Further, the stainer may stain the slice of the tissue block in order to highlight certain portions of the prepared slices 204 (e.g., an area of interest). In some embodiments, a computing device may include both the coverslipper and the stainer and the slide may be stained as part of the process of generating the slide. After staining, a coverslipper can encase the slice of the tissue block between a coverslip and the slide to generate the prepared slices 204. The prepared slices 204 may include the slice mounted in a certain position.

The prepared blocks 202 and the prepared slices 204 may be provided to an imaging device for imaging. In some embodiments, the prepared blocks 202 and the prepared slices 204 may be provided to the same imaging device. In other embodiments, the prepared blocks 202 and the prepared slices 204 are provided to different imaging devices. The imaging device can perform one or more imaging operations on the prepared blocks 202 and the prepared slices 204. In some embodiments, a computing device may include one or more of the tissue preparer, the microtome, the coverslipper, the stainer, and/or the imaging device.

The imaging device can capture an image of the prepared block 202 in order to generate the block image 206. The block image 206 may be a representation of the prepared block 202. For example, the block image 206 may be a representation of the prepared block 202 from one direction (e.g., from above). The representation of the prepared block 202 may correspond to the same direction as the prepared slices 204 and/or the slice of the tissue block. For example, if the tissue block is sliced in a cross-sectional manner in order to generate the slice of the tissue block, the block image 206 may correspond to the same cross-sectional view. In order to generate the block image 206, the prepared block 202 may be placed in a cradle of the imaging device and imaged by the imaging device. Further, the block image 206 may include certain characteristics. For example, the block image 206 may be a color image with a particular resolution level, clarity level, zoom level, or any other image characteristics.

The imaging device can capture an image of the prepared slices 204 in order to generate the slice image 208. The imaging device can capture an image of a particular slice of the prepared slices 204. For example, a slide may include any number of prepared slices and the imaging device may capture an image of a particular slice of the prepared slices. The slice image 208 may be a representation of the prepared slices 204. The slice image 208 may correspond to a view of the slice according to how the slice of the tissue block was generated. For example, if the slice of the tissue block was generated via a cross-sectional cut of the tissue block, the slice image 208 may correspond to the same cross-sectional view. In order to generate the slice image 208, the slide containing the prepared slices 204 may be placed in a cradle of the imaging device (e.g., in a viewer of a microscope) and imaged by the imaging device. Further, the slice image 208 may include certain characteristics. For example, the slice image 208 may be a color image with a particular resolution level, clarity level, zoom level, or any other image characteristics.

The imaging device can process the block image 206 in order to generate a pre-processed image 210 and the slice image 208 in order to generate the pre-processed image 212. The imaging device can perform one or more image operations on the block image 206 and the slice image 208 in order to generate the pre-processed image 210 and the pre-processed image 212. The one or more image operations may include isolating (e.g., focusing on) various features of the pre-processed image 210 and the pre-processed imaged 212. For example, the one or more image operations may include isolating the edges of a slice or a tissue block, isolating areas of interest within a slice or a tissue block, or otherwise modifying (e.g., transforming) the block image 206 and/or the slice image 208. In some embodiments, the imaging device can perform the one or more image operations on one of the block image 206 or the slice image 208. For example, the imaging may perform the one or more image operations on the block image 206. In other embodiments, the imaging device can perform first image operations on the block image 206 and second image operations on the slice image 208. The imaging device may provide the pre-processed image 210 and the pre-processed image 212 to the image analysis system to determine a likelihood that the pre-processed image 210 and the preprocessed image 212 correspond to the same tissue block.

### Slicing a Tissue Block

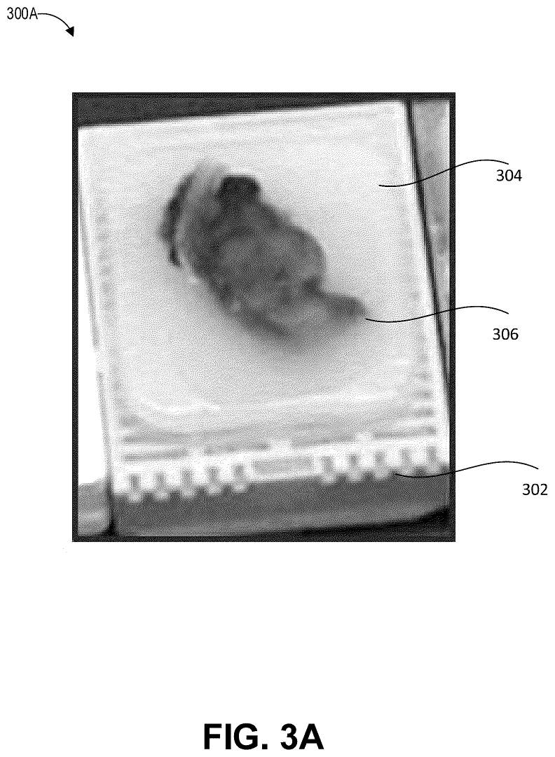

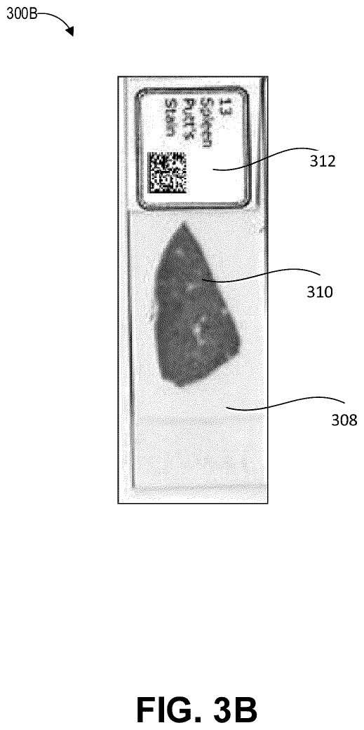

FIG. 3A illustrates an example prepared tissue block 300A according to some embodiments. The prepared tissue block 300A may include a tissue block 306 that is preserved (e.g., chemically preserved, fixed, supported) in a particular manner. In order to generate the prepared tissue block 300A, the tissue block 306 can be placed in a fixing agent (e.g., a liquid fixing agent). For example, the tissue block 306 can be placed in a fixative such as formaldehyde solution. The fixing agent can penetrate the tissue block 306 and preserve the tissue block 306. The tissue block 306 can subsequently be isolated in order to enable further preservation of the tissue block 306. Further, the tissue block 306 can be immersed in one or more solutions (e.g., ethanol solutions) in order to replace water within the tissue block 306 with the one or more solutions. The tissue block 306 can be immersed in one or more intermediate solutions. Further, the tissue block 306 can be immersed in a final solution (e.g., a histological wax). For example, the histological wax may be a purified paraffin wax. After being immersed in a final solution, the tissue block 306 may be formed into a prepared tissue block 300A. For example, the tissue block 306 may be placed into a mold filled with the histological wax. By placing the tissue block in the mold, the tissue block 306 may be molded (e.g., encased) in the final solution 304. In order to generate the prepared tissue block 300A, the tissue block 306 in the final solution 304 may be placed on a platform 302. Therefore, the prepared tissue block 300A may be generated. It will be understood that the prepared tissue block 300A may be prepared according to any tissue preparation methods.

FIG. 3B illustrates an example prepared tissue block 300A and an example prepared tissue slice 300B according to some embodiments. In order to generate the prepared tissue slice 300B, the prepared tissue block 300A may be sliced by a microtome. The microtome may include one or more blades to slice the prepared tissue block 300A. The microtome may take a cross-sectional slice 310 of the prepared tissue block 300A using the one or more blades. The cross-sectional slice 310 of the prepared tissue block 300A may include a slice 310 (e.g., a section) of the tissue block 306 encased in a slice of the final solution 304. In order to preserve the slice 310 of the tissue block 306, the slice 310 of the tissue block 306 may be modified (e.g., washed) to remove the final solution 304 from the slice 310 of the tissue block 306. For example, the final solution 304 may be rinsed and/or isolated from the slice 310 of the tissue block 306. Further, the slice 310 of the tissue block 306 may be stained by a stainer. In some embodiments, the slice 310 of the tissue block 306 may not be stained. The slice 310 of the tissue block 306 may subsequently be encased in a slide 308 by a coverslipper to generate the prepared tissue slice 300B. The prepared tissue slice 300B may include an identifier 312 identifying the tissue block 306 that corresponds to the prepared tissue slice 300B. Not shown in FIG. 3B, the prepared tissue block 300A may also include an identifier that identifies the tissue block 306 that corresponds to the prepared tissue block 300A. As the prepared tissue block 300A and the prepared tissue slice 300B correspond to the same tissue block 306, the identifier of the prepared tissue block 300A and the identifier 312 of the prepared tissue slice 300B may identify the same tissue block 306.

### Imaging Devices

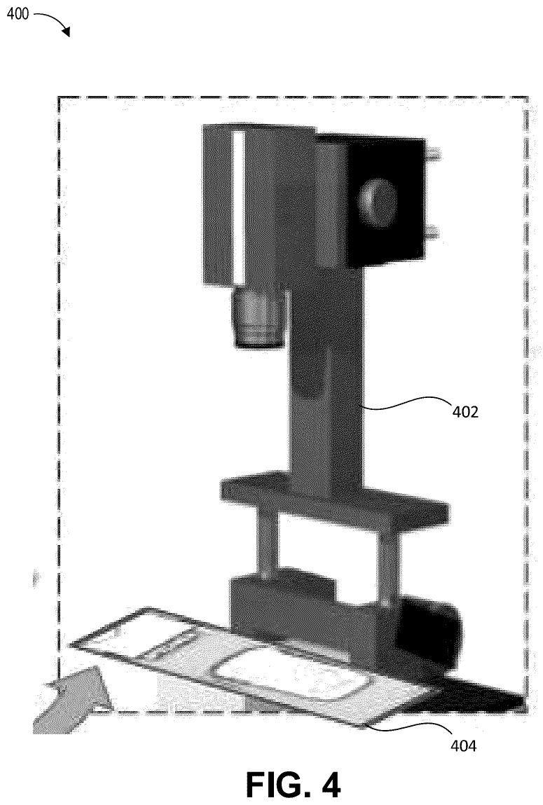

FIG. 4 shows an example imaging device 400, according to one embodiment. The imaging device 400 can include an imaging apparatus 402 (e.g., a lens and an image sensor) and a platform 404. The imaging device 400 can receive a prepared tissue block and/or a prepared tissue slice via the platform 404. Further, the imaging device can use the imaging apparatus 402 to capture image data corresponding to the prepared block and/or the prepared slice. The imaging device 400 can be one or more of a camera, a scanner, a medical imaging device, a microscope, etc. Further, the imaging device 400 can use imaging technologies such as X-ray radiography, magnetic resonance imaging, ultrasound, endoscopy, elastography, tactile imaging, thermography, medical photography, nuclear medicine functional imaging, positron emission tomography, single-photon emission computed tomography, etc. For example, the imaging device can be a magnetic resonance imaging (“MM”) scanner, a positron emission tomography (“PET”) scanner, an ultrasound imaging device, an x-ray imaging device, a computerized tomography (“CT”) scanner.

The imaging device 400 may receive one or more of the prepared tissue block and/or the prepared tissue slice and capture corresponding image data. In some embodiments, the imaging device 400 may capture image data corresponding to a plurality of prepared tissue slices and/or a plurality of prepared tissue blocks. The imaging device 400 may further capture, through the lens of the imaging apparatus 402, using the image sensor of the imaging apparatus 402, a representation of a prepared tissue slice and/or a prepared tissue block as placed on the platform. Therefore, the imaging device 400 can capture image data in order for the image analysis system to compare the image data to determine if the image data corresponds to the same tissue block.

### Automated Slide Staining

FIG. 5 illustrates an example of an automated slide staining apparatus 500 (or “automated slide stainer”). The automated slide staining apparatus 500 can be controlled to perform the methods described herein. In some embodiments, the automated slide staining apparatus 500 can include a controller (not shown in FIG. 5) that is configured to perform one or more of the methods described herein. For example, the slide staining apparatus 500 can be configured (or controlled) to receive slides having a biological sample thereon, determine a cumulative count of the slides received since the regent system was installed, and in response to the cumulative count being less than a first slide count S1, stain the slides using a first protocol having a plurality of steps for staining the set of slides using the reagent system, a step of the plurality of steps subjecting the set of slides to an eosin reagent followed by processing the slides to an alcohol reagent for a first time period. Further, in response to the cumulative slide count being equal to or greater than the first slide count S1, continue staining in-progress slides that are currently being processed with the first protocol, but do not start staining slides that have not yet begun being processed with the first protocol. After staining of the in-progress slides has been completed, the stain staining apparatus 500 can stain slides with using a second protocol, a step of the second protocol including processing the slides with an eosin reagent followed by processing the slides with an alcohol for a second time period, the second time period being shorter than the first time period.

In some embodiments, the automated slide staining apparatus 500 can be in configured with a controller (e.g., another computer system) that controls the operations of the slide staining apparatus to perform one or more of the methods described herein. In some embodiments, the automated slide staining apparatus 500 can be in communication with a controller (e.g., another computer system) that controls the operations of the slide staining apparatus to perform one or more of the methods described herein. In one example, the automated slide stainer can be a Histocore Spectra ST of Leica Biosystems. For ease of reference, staining a biological sample on a slide (e.g., a tissue or cell sample) will be referred to as staining a slide.

In the example illustrated in FIG. 5, the automated slide strainer 500 includes a number of features to stain tissue samples on slides. For example, the slide strainer 500 includes a transport arm 501 that is configured to transport a rack 511 of slides between reagent containers. The automated slide stainer 500 can also include wash stations 502, an oven 503, a lock 504 for the hood 520, a display 505 (e.g., a touchscreen display), and a LED strip to provide various operational indications. The automated slide strainer 500 also includes an RFID sensor 507, an on/off switch 508, USB ports 509, reagent container 510, and a container cover 512. The automated slide stainer 500 further includes a load drawer 513, an LED indicator and key 514 for the load drawer. The automated slide stainer 500 also includes a LED indicator and key 515 for the exit drawer. A slide counting sensor 517 is configured to count the slides that have been provided to the automated slide stainer for processing. The automated slide stainer 500 also includes a back plate 518, and lighting 519 positioned inside the hood 520. The automated slide stainer 500 can stain slides according to a first stain protocol using a reagent system, a controller (or control system) using the slide count to determine when to change to a second stain protocol using the same reagent system, the second protocol taking into account a state of the reagent system caused by staining a number of slides.

FIG. 6 is a block diagram that illustrates an example of interactions and processing actions of a slide staining assembly 605, a controller 610, and a slide counter 615 of an automated slide stainer 600, according to some embodiments. The slide staining assembly 605 can include portions of the slide stainer 600 that move a rack of slides into and out of the reagents and baths in accordance with a staining protocol. For example, features described in the example illustrated in FIG. 5, including the transport arm 501.

In operation, the slide counter 615 determines the cumulative number of slides that have been provided to be stained using a reagent system before the reagent system is changed or replenished. For example, the number of slides that have been loaded into a rack that has been input into the slide stainer 600 prior to processing of those slides. When a new reagent system is installed the counter can be reset to zero. In other embodiments, the counter current number may be considered to represent zero and the number of slides are counted relative to the current number. Slides are provided in racks, and the counter determines the number of slides provided before the rack of slides is processed. Information relating to the slide #is provided to the control 610 for controlling the staining process.

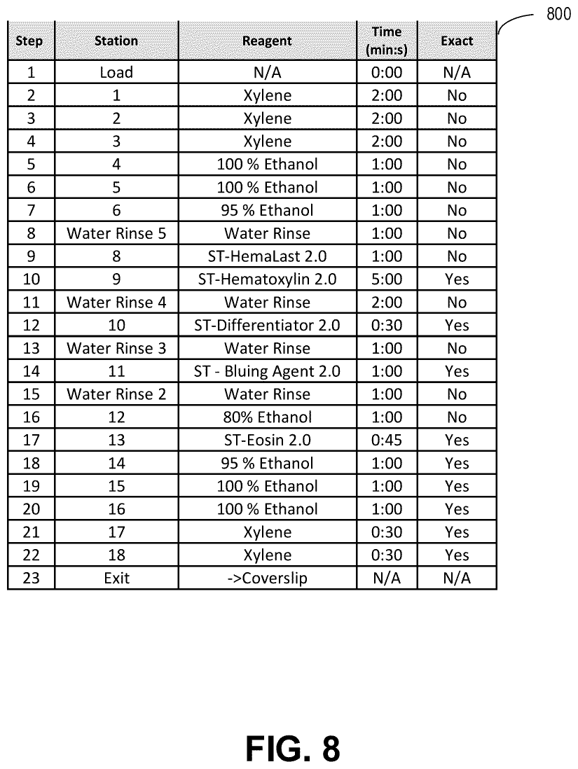

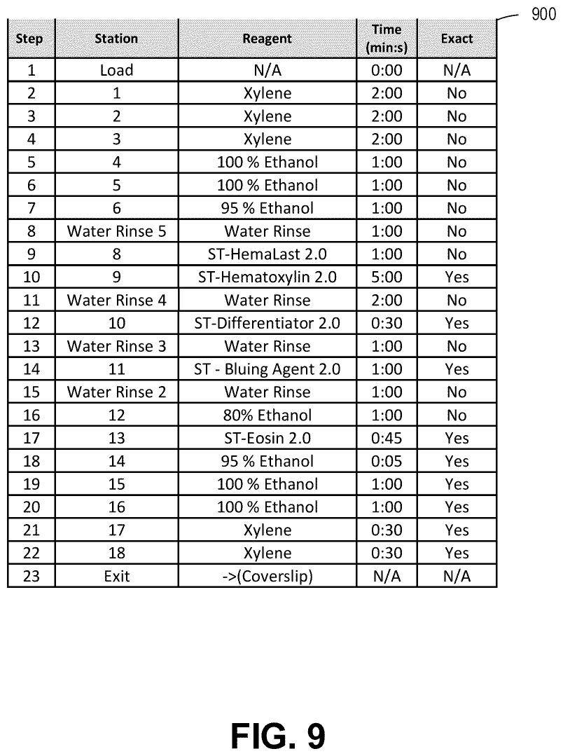

The controller 610 may be configured with one or more protocols for staining slides using a certain reagent system. In this example, the controller 610 is configured with a first protocol (for example, as shown in FIG. 8) and a second protocol (for example, as shown in FIG. 9). The first and second protocol indicate a sequence of steps to process a slide, subjecting the slide (e.g., immersing the slide) in a reagent or “bath” for a specific duration. Note that for this example, the first and second protocol include an Eosin reagent step, followed by a 95% Ethanol reagent step. The controller receives the slide count information from the slide counter 615 and controls the slide staining assembly 605 to stain slides using the first protocol, as illustrated in blocks 606 and 607. The controller 610 controls the slide staining assembly to stain the slides using the first protocol until the slide counter reaches a predetermined number S1, as illustrated in block 612. The controller operates the slide staining assembly 605 such that racks of slides that have already started the staining process when S1 is reached (“in-process racks”) continue to be processed using the first protocol, but new racks of slides are not started. In this example, the slide count number S1 is 2400.

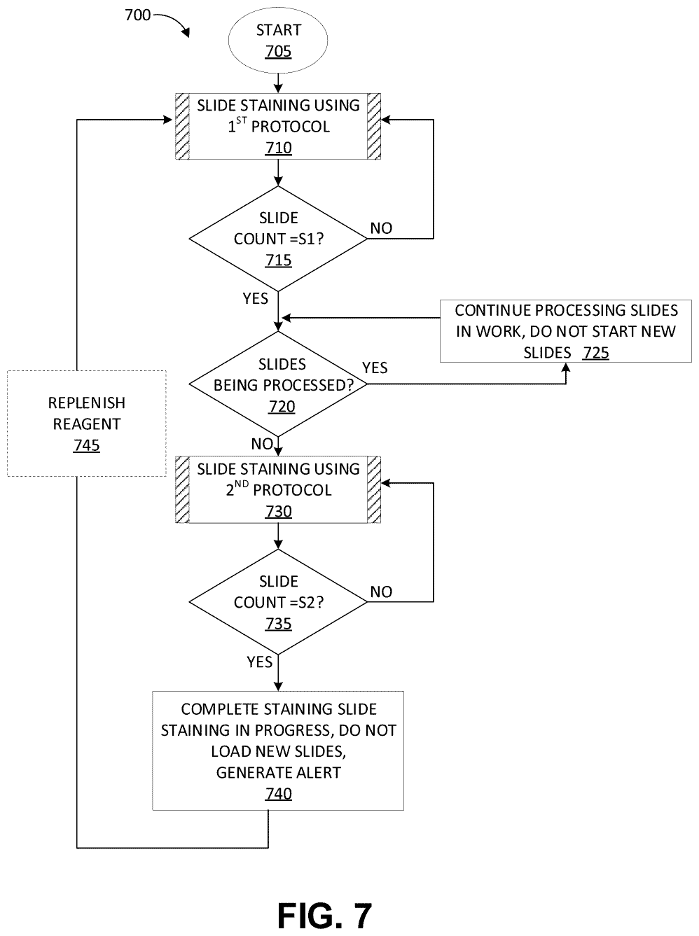

Once the in-process racks are completed, the controller 610 operates the slide staining assembly to stain slides using the second protocol as illustrated in controller block 613 and slide staining assembly block 605. In this example, both the first protocol and the second protocol have 23 steps including a Step 1 “Load” and a step 23 “Coverslip.” Steps 2-17 of the first and second protocol are also the same, and use various reagents and water rinses as illustrated in the tables shown in FIGS. 8 and 9. FIG. 8 is a table that illustrates an example of a first protocol of a reagent system for staining slides, according to some embodiments. The first protocol can be used, for example, as a default protocol for a first portion of the slide staining process illustrated in FIG. 7. FIG. 9 is a table that illustrates an example of a second protocol of a reagent system for staining slides, according to some embodiments. The second protocol can be used, for example, as the protocol for a second portion of the slide staining process illustrated in FIG. 7, that is, the protocol that can be used after a certain count of slides has been reached (e.g., 2400 slides), and can continue to be used until the reagent system is replenished.

As illustrated in the FIGS. 8 and 9, Step 17 of both the first and second protocol are also the same and include using a ST-Eosin 2.0 reagent for a duration of 45 seconds. However, after Step 17 the protocols differ. In the first protocol (FIG. 8) Step 18 uses 95% ethanol for a duration of 1 minute; Step 19 of first protocol 800 uses 100% Ethanol for 1 minute; Step 20 of first protocol 800 uses 100% Ethanol for 1 minute; and Steps 21 and 22 of the first protocol 800 uses Xylene for 2 minutes each. In the second protocol (FIG. 9) Step 18 uses 95% ethanol for a duration of 5 seconds; Step 19 of second protocol (FIG. 9) uses 100% Ethanol for 1 minute; Step 20 of first protocol 800 uses 100% Ethanol for 1 minute. Steps 21 and 22 of the first protocol 800 uses Xylene for 30 seconds each. The second protocol operates when the reagent system is a certain portion through a certain cumulative number of slides (e.g., at slide count S1) to decrease the time of the coloration recession.

In some embodiments, the slide count S1 is a number greater than or equal to 2200 and less than or equal to 2600. In some embodiments, the slide count S1 is a number greater than or equal to 2300 and less than or equal to 2500. In some embodiments, the slide count S1 is a number greater than or equal to 2350 and less than or equal to 2450. In some embodiments the first slide count S1 is 2400, plus or minus 50. For example, the first slide count S1 can be 2350, 2351, 2352, 2353, 2354, 2355, 2356, 2357, 2358, 2359, 2360, 2361, 2362, 2363, 2364, 2365, 2366, 2367, 2368, 2369, 2370, 2371, 2372, 2373, 2374, 2375, 2376, 2377, 2378, 2379, 2380, 2381, 2382, 2383, 2384, 2385, 2386, 2387, 2388, 2389, 2390, 2391, 2392, 2393, 2394, 2395, 2396, 2397, 2398, 2399, 2400, 2401, 2402, 2403, 2404, 2405, 2406, 2407, 2408, 2409, 2410, 2411, 2412, 2413, 2414, 2415, 2416, 2417, 2418, 2419, 2420, 2421, 2422, 2423, 2424, 2425, 2426, 2427, 2428, 2429, 2430, 2431, 2432, 2433, 2434, 2435, 2436, 2437, 2438, 2439, 2440, 2441, 2442, 2443, 2444, 2445, 2446, 2447, 2448, 2449, or 2450.

The reagent system can only be used for a certain number of slides, which is indicated by slide count number S2. When the controller 610 receives information that the counter has reached the second predetermined number S2, at block 614 the controller 610 stops the intake of new slides (that is, does not start new slides in the staining process). The controller 610 controls the slide staining assembly 605 to continue processing slides that are in-progress of being stained such that they complete their staining using the second protocol, and then stops staining slides as indicated in block 609. In some examples, the slide count number S2 is 3000 (indicating the regent systems needs to be changed after about or at 3000 slides are stained.

FIG. 7 is a process-flow diagram that illustrates a process (or method) of staining slides based at least in part on an input that indicates a cumulative count of a number of slides that have been processed for staining with a reagent system. Although the parts of the process-flow diagram may be described in terms of the process steps, an automated slide stainer executes the process. The process illustrated in FIG. 7 starts at 705 where a reagent system has been loaded into a slide stainer apparatus, and the slide counter has been reset to zero, or the number of the slide counter can be used to indicate a relative slide count of zero. As slides are loaded into the slide stainer apparatus and before the processing of the slides start, the slides are counted.

At 710 the process starts to stain slides using a first protocol. The first protocol can include multiple steps that can relate to subjecting a slide to a reagent or a bath for a particular period of time. In various examples, a protocol may include one or more reagents of Xylene, 100% Ethanol, 95% Ethanol, ST-HemaLast 2.0, ST-Differentiator, ST-Bluing Agent 2.0, 80% ethanol, and ST-Eosin 2.0. As described above, an example of a first protocol 800 is illustrated in the table of FIG. 8, and an example of a second protocol is illustrated in the table of FIG. 9. At 715 the slide count is checked to see if it is equal to, or greater than, a first slide count S1. If it is not, slide staining continues using the first protocol. If the slide count is equal to or greater than the first slide count 51, the process moves to 720 where it determines if any slides are still being processed with the first staining protocol. If yes, then the process 700 moves to 725 where the in-process slides continue to be processed, and the process moves to 720 and determines if they are now complete.

When all of the previous in-process slides have completed the staining process under the first protocol, the process 700 moves to 730 where it begins to process the next slides using the second protocol, which has a different set of Steps 18-22 compared to the first protocol. That is, Steps 18-22 after the Eosin reagent (Step 17) are different in the second protocol to decrease the speed of the color recession.

The process 700 then moves to 735 where it checks to see if the slide count as reached a second predetermined slide number S2 which is indicative of the reagent system needing to be changed. Once the slide count has reached slide number S2, the process 700 completes the slides that are in the process of being stained using the second protocol (in-process slides) and does not load new slides. Also, at 740 the process 700 can generate and communicate an alert indicating the reagent system needs to be replaced. In some embodiments, the alert can be displayed on a display of the automated slide stainer. In some embodiments, the alert can be communicated to a user device (e.g., a smart phone) and/or another computer. The process 700 can then move to 745 where the reagent system is changed or replenished, the counter is reset to zero, and slide staining can again begin at 710.

FIG. 10 is an example computing system controller which can implemented in an automated slide stainer to perform any of the processes described herein, for example, the slide staining process illustrated in FIG. 7. The computing system 1000 may include: one or more computer processors 1002, such as physical central processing units (“CPUs”); one or more network interfaces 1004, such as a network interface cards (“NICs”); one or more computer readable medium drives 1006, such as a high density disk (“HDDs”), solid state drives (“SDDs”), flash drives, and/or other persistent non-transitory computer-readable media; an input/output device interface 1008, such as an input/output (“IO”) interface in communication with one or more microphones; and one or more non-transitory computer readable memories 1010, such as random access memory (“RAM”) and/or other volatile non-transitory computer-readable media.

The network interface 1004 can provide connectivity to one or more networks or computing systems. The computer processor 1002 can receive information and instructions from other computing systems or services via the network interface 1004. The network interface 1004 can also store data directly to the computer-readable memory 1010. The computer processor 1002 can communicate to and from the computer-readable memory 1010, execute instructions and process data in the computer readable memory 1010, etc.

The computer readable memory 1010 may include computer program instructions that the computer processor 1002 executes in order to implement one or more embodiments of methods for controlling an automatic slide staining apparatus for staining of cells and tissue samples on slides before pathological analysis, where the slide staining apparatus operable to stain multiple sets of slides simultaneously and configured with a reagent system having a plurality of reagents. Such methods can include receiving slides having a biological sample thereon, determining a cumulative count of the slides received since the regent system was installed, in response to the cumulative count being less than a first slide count S1, stain the slides using a first protocol having a plurality of steps for staining the set of slides using the reagent system, a step of the plurality of steps subjecting the set of slides to an eosin reagent followed by processing the slides to an alcohol reagent for a first time period, in response to the cumulative slide count being equal to or greater than the first slide count S1, continue staining in-progress slides that are currently being processed with the first protocol, but do not start staining slides that have not yet begun being processed with the first protocol, and after staining of the in-progress slides has been completed, stain slides with using a second protocol, a step of the second protocol including processing the slides with an eosin reagent followed by processing the slides with an alcohol for a second time period, the second time period being shorter than the first time period. The computer readable memory 1010 may further include, for example, computer program instructions that the computer processor 1002 executes in order to, in response to the cumulative slide count being greater than a second slide count S2, continue staining in-progress slides currently being processed with the second protocol, but do not start staining slides that have not yet begun being processed with the second protocol.

The computer readable memory 1010 can store an operating system 1012 that provides computer program instructions for use by the computer processor 1002 in the general administration and operation of the computing system 1000. The computer readable memory 1010 can further include computer program instructions and other information for implementing aspects of the present disclosure. For example, in one embodiment, the computer readable memory 1010 may include a machine learning model 1014 (also referred to as a machine learning algorithm). As another example, the computer-readable memory 1010 may include image data 1016. In some embodiments, multiple computing systems 1000 may communicate with each other via respective network interfaces 1004, and can implement multiple sessions each session with a corresponding connection parameter (e.g., each computing system 1000 may execute one or more separate instances of the method 600), in parallel (e.g., each computing system 1000 may execute a portion of a single instance of the method 700), etc.

### CONCLUSION

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the disclosure should not be taken to imply that the terminology is being re-defined herein to be restricted to including any specific characteristics of the features or aspects of the technology with which that terminology is associated.

It will be appreciated by those skilled in the art that various modifications and changes can be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures can be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations can be expressly set forth herein for sake of clarity.

Directional terms used herein (e.g., top, bottom, side, up, down, inward, outward, etc.) are generally used with reference to the orientation shown in the figures and are not intended to be limiting. For example, the top surface described above can refer to a bottom surface or a side surface. Thus, features described on the top surface may be included on a bottom surface, a side surface, or any other surface.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims can contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The term “comprising” as used herein is synonymous with “including,” “containing,” or “characterized by,” and is inclusive or open-ended and does not exclude additional, unrecited elements or method steps. The term “about” is meant to indicate that the number it modifies can be that number, or close to that number, that is, plus or minus 10% of that number.

The above description discloses several methods and materials of the present invention(s). This invention(s) is susceptible to modifications in the methods and materials, as well as alterations in the fabrication methods and equipment. Such modifications will become apparent to those skilled in the art from a consideration of this disclosure or practice of the invention(s) disclosed herein. Consequently, it is not intended that this invention(s) be limited to the specific embodiments disclosed herein, but that it cover all modifications and alternatives coming within the true scope and spirit of the invention(s) as embodied in the attached claims.

1. An automatic slide staining apparatus for staining of cells and tissue samples on slides before pathological analysis, the slide staining apparatus operable to stain multiple sets of slides simultaneously and configured with a reagent system having a plurality of reagents, the apparatus comprising:
a slide counter configured to count slides provided to the apparatus for staining;
a controller having a non-transitory memory component with instructions thereon, and one or more processors configured to execute the instructions to:
(a) determine a cumulative count of a set of received slides since the regent system was installed, each set of slides having one or more slides;
(b) in response to the cumulative count being less than a first slide count S1, stain the set of slides using a first protocol having a plurality of steps for staining the set of slides in the reagent system, a step of the plurality of steps subjecting the set of slides to an eosin reagent followed by subjecting the set of slides to an alcohol reagent for a first time period, and repeat process items (a)-(b);
(c) in response to the cumulative slide count being greater than the first slide count S1, continue staining in-progress slides that are currently being processed with the first protocol, but do not start staining slides that have not yet begun being processed with the first protocol;
after staining of the in-progress slides has been completed:
(d) receive another set of slides having a biological sample thereon;
(e) determine a cumulative count of the slides received since the regent system was installed;
(f) in response to the cumulative count being less than a second slide count S2, stain the received set of slides using a second protocol having a plurality of steps for staining the set of slides in the reagent system, a step of the second protocol including subjecting the set of slides to an eosin reagent followed by subjecting the set of slides to an alcohol for a second time period where the second time period is shorter than the first time period, and repeat process steps (d)-(f); and
(g) in response to the cumulative slide count being greater than the second slide count S2, continue staining in-progress slides currently being processed with the second protocol, but not start staining slides that have not yet begun being processed with the second protocol.

2. The apparatus of claim 1, wherein the first slide count S1 is greater than or equal to 2200 and less than or equal to 2600.

3. The apparatus of claim 1, wherein the first slide count S1 is greater than or equal to 2300 and less than or equal to 2500.

4. The apparatus of claim 1, wherein the first slide count S1 is greater than or equal to 2350 and less than or equal to 2450.

5. The apparatus of claim 1, wherein the first slide count is 2400.

6. The apparatus of claim 1, wherein the first slide count S1 equal 0.8*S2.

7. The apparatus of claim 1, wherein the first slide count S1 is between 0.7*S2 and 0.9*S2.

8. The apparatus of claim 1, wherein the second slide count S2 is between 2800 and 3200.

9. The apparatus of claim 1, wherein the second slide count S2 is between 2900 and 3100.

10. (canceled)

11. The apparatus of claim 1, wherein the first protocol and the second protocol have two or more of the same steps, before the eosin reagent step, of the same duration.

12. The apparatus of claim 1, wherein the first protocol and the second protocol include at least two of the same reagent steps after the eosin reagent step, wherein the at least two reagent steps of the second protocol after the eosin reagent step are of a shorter duration than the corresponding two or more steps of the first protocol.

13. The apparatus of claim 1, wherein the first and second protocols sequentially include, after the eosin reagent step, a 95% ethanol reagent step, a first 100% ethanol reagent step, a second 100% ethanol reagent step, a first xylene step, and a second xylene step.

14. The apparatus of claim 1, wherein the 95% ethanol reagent step of the first protocol has a duration of more than three times as long as the 95% ethanol reagent step of the second protocol.

15. The apparatus of claim 3, wherein the 95% ethanol reagent step of the first protocol has a duration of about one minute, and the 95% ethanol reagent step of the second protocol has a duration of about 5 seconds.

16. The apparatus of claim 1, wherein the first protocol sequentially includes, after the eosin reagent step, a 95% ethanol reagent step of one minute, a first 100% ethanol reagent step of one minute, a second 100% ethanol reagent step of one minute, a first xylene step of about 30 seconds, and a second xylene step of about 30 seconds, and the second protocol sequentially includes, after the eosin reagent step, a 95% ethanol reagent step of about 5 seconds, a first 100% ethanol reagent step of about one minute, a second 100% ethanol reagent step of about one minute, a first xylene step of about 30 seconds, and a second xylene step of about 30 seconds.

17.-20. (canceled)

21. A non-transitory computer readable medium for controlling a slide staining apparatus for staining of cells and tissue samples on slides, the computer readable medium having program instructions for causing a hardware processor to perform a method of:
(a) determining a cumulative count of a set of received slides since a regent system was installed, each set of slides having one or more slides;
(b) in response to the cumulative count being less than a first slide count S1, staining the set of slides using a first protocol having a plurality of steps for staining the set of slides in the reagent system, a step of the plurality of steps subjecting the set of slides to an eosin reagent followed by subjecting the set of slides to an alcohol reagent for a first time period, and repeat process items (a)-(b);
(c) in response to the cumulative slide count being greater than the first slide count S1, continuing to stain in-progress slides that are currently being processed with the first protocol, but do not start staining slides that have not yet begun being processed with the first protocol;
after staining of the in-progress slides has been completed:
(d) receiving another set of slides having a biological sample thereon;
(e) determining a cumulative count of the slides received since the regent system was installed;
(f) in response to the cumulative count being less than a second slide count S2, staining the received set of slides using a second protocol having a plurality of steps for staining the set of slides in the reagent system, a step of the second protocol including subjecting the set of slides to an eosin reagent followed by subjecting the set of slides to an alcohol for a second time period where the second time period is shorter than the first time period, and repeat process steps (d)-(f); and
(g) in response to the cumulative slide count being greater than the second slide count S2, continuing to stain in-progress slides currently being processed with the second protocol, but not start staining slides that have not yet begun being processed with the second protocol.

22. The non-transitory computer readable medium of claim 21, wherein the first protocol and the second protocol include at least two of the same reagent steps after the eosin reagent step, wherein the at least two reagent steps of the second protocol after the eosin reagent step are of a shorter duration than the corresponding two or more steps of the first protocol.

23. (canceled)

24. The non-transitory computer readable medium of claim 21, wherein the first and second protocols sequentially include, after the eosin reagent step, a 95% ethanol reagent step, a first 100% ethanol reagent step, a second 100% ethanol reagent step, a first xylene step, and a second xylene step, wherein the 95% ethanol reagent step of the first protocol has a duration of more than three times as long as the 95% ethanol reagent step of the second protocol.

25. The non-transitory computer readable medium of claim 21, wherein the first and second protocols sequentially include, after the eosin reagent step, a 95% ethanol reagent step, a first 100% ethanol reagent step, a second 100% ethanol reagent step, a first xylene step, and a second xylene step, wherein the 95% ethanol reagent step of the first protocol has a duration of about one minute, and the 95% ethanol reagent step of the second protocol has a duration of about 5 seconds.

26. (canceled)

27. A method for controlling an automatic slide staining apparatus for staining of cells and tissue samples on slides before pathological analysis, the slide staining apparatus operable to stain multiple sets of slides simultaneously and configured with a reagent system, the method comprising:
(a) determine a cumulative count of a set of received slides since the regent system was installed, each set of slides having one or more slides;
(b) in response to the cumulative count being less than a first slide count S1, stain the set of slides using a first protocol having a plurality of steps for staining the set of slides in the reagent system, a step of the plurality of steps subjecting the set of slides to an eosin reagent followed by subjecting the set of slides to an alcohol reagent for a first time period, and repeat process items (a)-(b);
(c) in response to the cumulative slide count being greater than the first slide count S1, continue staining in-progress slides that are currently being processed with the first protocol, but do not start staining slides that have not yet begun being processed with the first protocol;
after staining of the in-progress slides has been completed:
(d) receive another set of slides having a biological sample thereon;
(e) determine a cumulative count of the slides received since the regent system was installed;
(f) in response to the cumulative count being less than a second slide count S2, stain the received set of slides using a second protocol having a plurality of steps for staining the set of slides in the reagent system, a step of the second protocol including subjecting the set of slides to an eosin reagent followed by subjecting the set of slides to an alcohol for a second time period where the second time period is shorter than the first time period, and repeat process steps (d)-(f); and
(g) in response to the cumulative slide count being greater than the second slide count S2, continue staining in-progress slides currently being processed with the second protocol, but not start staining slides that have not yet begun being processed with the second protocol.

28.-48. (canceled)
